(19) United States
(12) Patent Application Publication
(10) Pub. No.: US 2012/0054850 A1
(43) Pub. Date: Mar. 1, 2012

(54) Proxying for Clusters of Fiber Channel Servers to Reduce Configuration Requirements for Fiber Channel Storage Arrays

(75) Inventors: Rajeev Bhardwaj, Saratoga, CA (US); Subrata Banerjee, Los Altos, CA (US)

(73) Assignee: CISCO TECHNOLOGY, INC., San Jose, CA (US)

(21) Appl. No.: 12/872,027

(22) Filed: Aug. 31, 2010

(51) Int. Cl. G06F 21/00

(52) U.S. Cl. 726/12

(57) ABSTRACT

Techniques are provided for receiving at a proxy device in a network, a login request from a source device, e.g., a Fiber Channel server in a server virtualization cluster, to access a destination device, a Fiber Channel storage array. The source device does not or need not have direct access to the destination device. A response to the login request is sent that is configured to appear to the source device that the response is from the destination device. The proxy device logs into the destination device on behalf of the source device to obtain access to the destination device. The proxy device receives first network traffic frames associated with a service flow between the source device and the destination device from the source device that are destined for the destination device. Information is overwritten within the first network traffic frames such that the first network traffic frames appear to originate from the proxy device when transmitted to the destination device. The first network traffic frames are transmitted from the proxy device to the destination device. Techniques are also provided herein for performing similar operations on frames sent from the destination device to the proxy device.

### TECHNICAL FIELD

The present disclosure generally relates to Storage Area Networks (SANs) and more particularly to providing a login proxy to Fiber Channel (FC) storage arrays for FC servers.

### BACKGROUND

Storage Area Networks (SANs) reliably store large amounts of data for an organization. Clusters of storage devices, e.g., FC storage arrays, in one location are called SAN islands and communicate using the FC Protocol. Users accessing a SAN typically reside on an Ethernet based Local Area Network (LAN) at another location that may be coupled to an FC server cluster for communication with the FC storage array. To mediate communication between the FC server cluster and the FC storage array, an FC switch network (also called “switched fabric”) is employed.

Recent advances have led to virtualization resulting in the creation of Virtual SANs (VSANs) and Virtual LANs (VLANs). VSANs and VLANs remove the physical boundaries of networks and allow a more functional approach. For example, an engineering department VLAN can be associated with an engineering department VSAN, or an accounting department VLAN can be associated with an accounting department VSAN, regardless of the location of network devices in the VLAN or storage devices in the VSAN. In a virtualized server environment typically there are multiple virtual machines (VMs) running on each physical server in the FC server cluster that are capable of migrating from server to server.

The physical servers are typically grouped in clusters. Each physical server in a cluster needs to have access to the same set of storage ports so that when a VM moves from one physical server to another physical server, the VM still has access to the same set of applications and data in the storage device. Due to this requirement, whenever a new physical server is added to the cluster, the access permissions in the storage device need to be modified to allow the new server to access it. This creates operational challenges due to the coordination needed between the server administrators and the storage administrators for change management.

### BRIEF DESCRIPTION OF THE DRAWINGS

FIG. 1 is an example of a block diagram of a network with a proxy device that is configured to proxy for an FC server accessing an FC storage array.

FIG. 2 is an example of a block diagram of a proxy device that is configured to proxy for an FC server accessing an FC storage array.

FIG. 3 is an example of a flowchart generally depicting a process for a proxy device to proxy for an FC server sending frames to an FC storage array.

FIG. 4 is an example of a flowchart depicting a continuation of the process from FIG. 3 for the proxy device to route network traffic in the reverse direction from the FC storage array to the FC server.

FIG. 5 is an example of a ladder diagram generally depicting service flows between physical FC servers and a physical FC storage array in which the proxy device overwrites identifying information in the service flows.

FIG. 6 is an example of information that may be stored by the proxy device to track service flows.

### DESCRIPTION OF EXAMPLE EMBODIMENTS

Overview

Techniques are provided herein for receiving at a proxy device in a network, a login request from a source device to access a destination device. The source device does not have direct access permission to the destination device. A response to the login request is sent that is configured to appear to the source device that the response was sent from the destination device. The proxy device logs into the destination device on behalf of the source device to obtain access to the destination device. Thereafter, the proxy device receives first network traffic frames associated with a service flow between the source device and the destination device from the source device that are destined for the destination device. Information is overwritten within the first network traffic frames such that the first network traffic frames appear to originate from the proxy device when transmitted to the destination device. The first network traffic frames are transmitted from the proxy device to the destination device. Similar operations are performed for frames sent from the destination device to the source device. At the proxy device, second network traffic frames are received from the destination device that are destined for the source device. Information within the second network traffic frames is overwritten such that the second network traffic frames appear to originate from the destination device when transmitted to the source device. The second network traffic frames are transmitted from the proxy device to the source device.

While the terms “source device” and “destination device” are used herein, these are meant only for explanatory purposes. Data is sent in both directions between these two devices. The source device may be viewed as a first device and the destination device viewed as a second device. In the specific examples described herein, the first device is a FC server and the second device is a FC storage array.

### EXAMPLE EMBODIMENTS

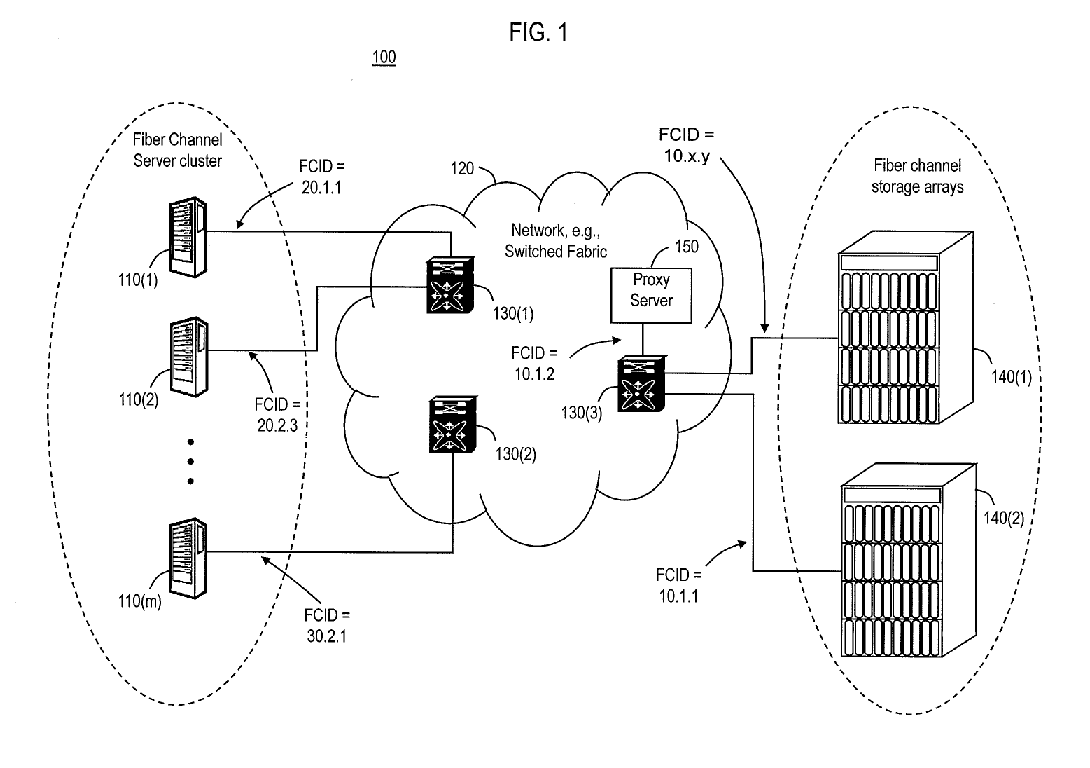

Referring first to FIG. 1, an example system 100 is shown. System 100 comprises a Fibre-Channel (FC) server cluster with FC physical servers 110(1)-110(m), a FC network (also referred to herein as a “switched fabric”) 120 with comprising a plurality of switches, examples of which are shown at reference numerals 130(1)-130(3), a plurality of FC storage arrays, examples of which are shown at 140(1) and 140(2), and a proxy server 150. Each of the FC servers 110(1)-110(m) and the FC storage arrays 140(1) and 140(2) has an address that is assigned by the respective connecting switch that contains a 24-bit FC identifier (FCID).

The FCID may be separated into three bytes in a Domain.Area.Port notation that may be used, e.g., in a frame header to identify source ports of a source device and destination ports of a destination device. The domain is always associated with the respective switch. In this example, communications between FC physical servers 110(1) and 110(2) and switch 130(1) uses FCID 20.1.1 for FC server 110(1) and FCID 20.2.3 for server 110(2) where “20” is the domain for switch 130(1). Thus, all connections to switch 130(1) will use a 20.x.y FCID. Switch 130(2) has domain of 30 and switch 130(3) has a domain of 10. FCIDs with arbitrary areas and ports are assigned for communications on the various paths shown in FIG. 1.

One or more VMs may be running on each of the FC physical servers 110(1)-110(m). Individual VMs may migrate from server to server. As such, each of the FC servers 110(1)-110(m) needs to access the same set of storage ports so that the VMs can access the same applications and data that they operate on in the FC storage arrays 140(1) and 140(2) as they migrate from one FC server to another.

When a new FC server is added to the FC server cluster, the new FC server needs the same access permissions to the FC storage array(s) as other FC servers in the same cluster, e.g., FC servers 110(1)-110(m), so that the VMs can retain access to the applications and data as they migrate to the new FC server. The process of adding a new FC server necessitates the coordination of two network administrators, one for the FC server cluster and one for the FC storage array, in order to set up the required access permissions on both systems.

For example, when a new physical server is deployed in a virtualization server cluster, the server administrator needs to ask the storage administrator to add the new server in the access control list of the storage array. This may be done in the form of a Media Access Control (MAC)-based access control, Port World Wide Name (PWWN)-based zoning, or using Logical Unit Number (LUN) masking in the storage array. LUNs provide a way to logically divide storage space, e.g., hard drive or optical drive volumes. For FC storage arrays, the LUN masking configuration has to be modified to allow the new server to access a selected set of LUNs. All the servers in a virtualization cluster are typically zoned with the same set of storage ports and they are given access to the same set of LUNs. Thus, when a new server is added, the operation tasks described above have to be performed. In addition, the increasing demand for virtualization places a greater demand on the storage array because the ports in the storage array have a limit on the number of servers that can be simultaneously logged in.

However, by assigning access permissions to the proxy server 150, the proxy server 150 may proxy for any newly added FC servers by handling the login procedures and translating or overwriting identification information, e.g., a source or destination FCID and an originator exchange identifier (OXID) that is carried in every FC frame, in the network traffic headers such that the FC storage array is unaware of newly added FC servers. Any frames sent back to the FC server will echo the OXID. Thus, OXIDs can be used by the various devices to track service flows, i.e., the device can match response messages to read or write request messages.

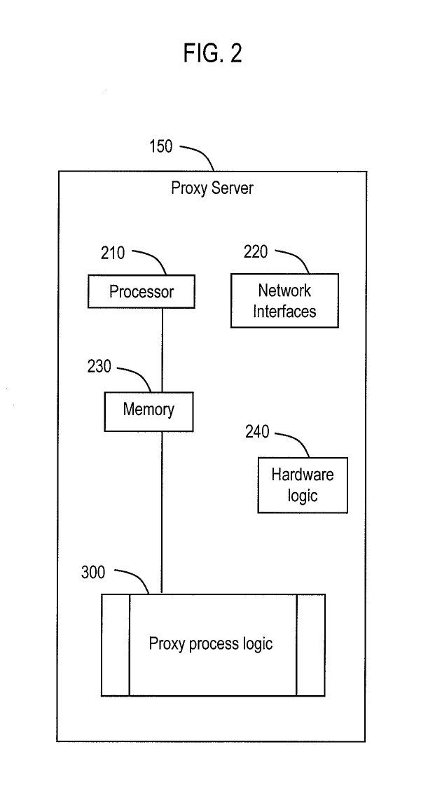

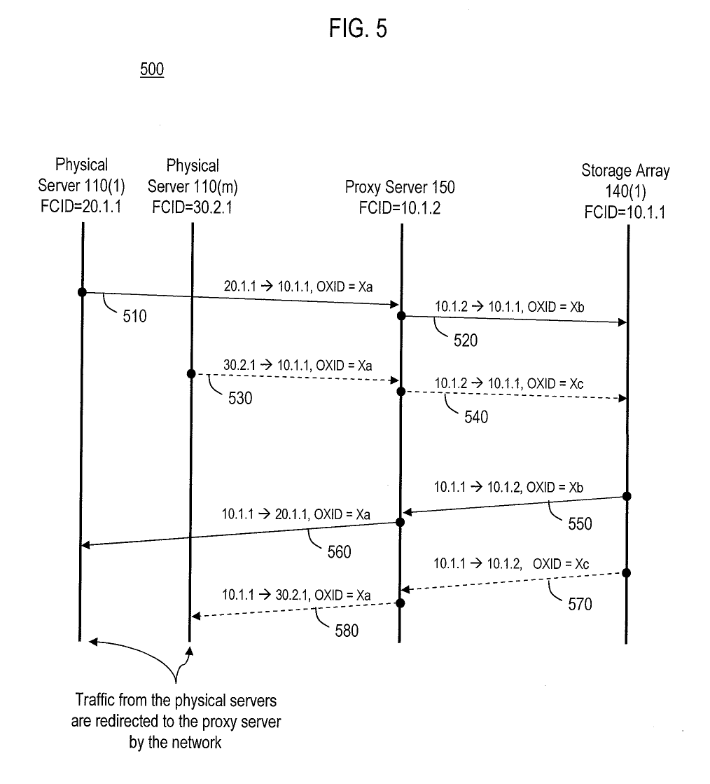

The proxy server also reduces the number of server logins to the storage array by representing more than one physical server. In other words, the proxy server 150 can be thought of as an instantiated virtual server that may represent some or all of the physical FC servers 110(1)-110(m). As shown in FIG. 1, proxy server 150 is associated with or hosted by switch 130(3) since switch 130(3) is connected to the FC storage array. However, the proxy server may be a separate device and/or implemented in another switch, or both. Moreover, there may be multiple proxy servers employed in system 100. The process logic executed by the proxy server 150 will be generally described in connection with FIGS. 2-4, and a specific example will be described in connection with FIG. 5.

Referring to FIG. 2, an example block diagram of a proxy device, e.g., proxy server 150, is shown. The proxy server 150 comprises a data processing device 210, a plurality of network interfaces 220, a memory 230, and hardware logic 240. Resident in the memory 230 is software for proxy process logic 300. Process logic 300 may also be implemented in hardware using hardware logic 240, or be implemented in a combination of both hardware and software.

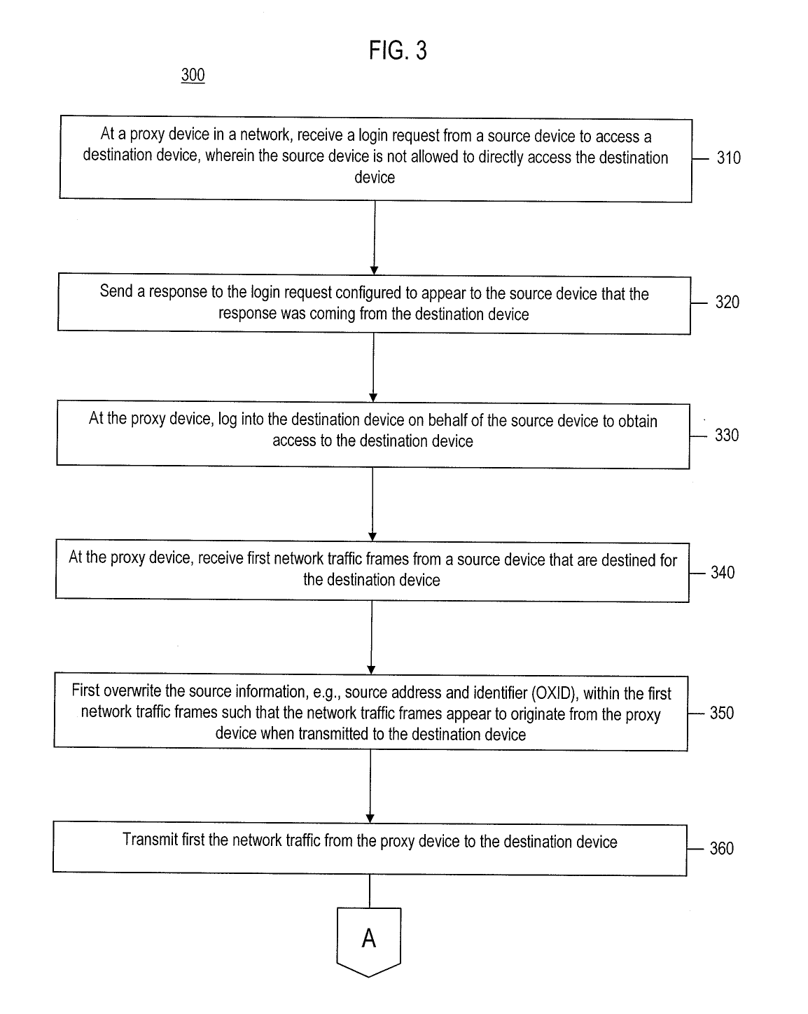

The data processing device 210 is, for example, a microprocessor, a microcontroller, systems on a chip (SOCs), or other fixed or programmable logic. The data processing device 210 is also referred to herein simply as a processor. The memory 230 may be any form of random access memory (RAM) or other data storage block that stores data used for the techniques described herein. The memory 230 may be separate or part of the processor 210. Instructions for performing the process logic 300 may be stored in the memory 230 for execution by the processor 210 such that when executed by the processor, causes the processor to perform the operations describe herein in connection with FIGS. 3-5. The network interfaces 220 enable communication over network 120 shown in FIG. 1, and thus include a FC interface. It should be understood that any of the devices in system 100 may be configured with a similar hardware or software configuration as proxy server 150.

The functions of the processor 210 may be implemented by a processor or computer readable tangible medium encoded with instructions or by logic encoded in one or more tangible media (e.g., embedded logic such as an application specific integrated circuit (ASIC), digital signal processor (DSP) instructions, software that is executed by a processor, etc.), wherein the memory 230 stores data used for the computations or functions described herein (and/or to store software or processor instructions that are executed to carry out the computations or functions described herein). Thus, functions of the process logic 300 may be implemented with fixed logic or programmable logic (e.g., software or computer instructions executed by a processor or field programmable gate array (FPGA)).

Hardware logic 240 may be used to implement fast address and OXID rewrites/overwrites in hardware, e.g., at an ASIC level, in the FC frames without involving the switch Central Processing Unit (CPU), e.g., processor 210, or a separate processor associated with one of the network interfaces 220. The hardware logic 240 may be coupled to processor 210 or be implemented as part of processor 210.

Referring to FIG. 3, an example of a flowchart is shown that generally depicts the operations of the process logic 300 that proxies for FC servers in a FC cluster. At 310, at a proxy device in a network (e.g., proxy server 150), a login request is received from a source device, e.g., FC server 110(1) in FIG. 1, to access a destination device, e.g., FC storage array 140(1), where the source device cannot directly access the destination device. In one example, the source device is an FC server (in an FC server cluster) that does not have access permissions to login to an FC storage array. At 320, a response to the login request is sent to the source device. The response is configured to appear to the source device that it was sent from the destination device, but it was actually sent by the proxy device. At this point in time, the source device is unaware of the proxy device and operates as if it were in direct communication with the destination device.

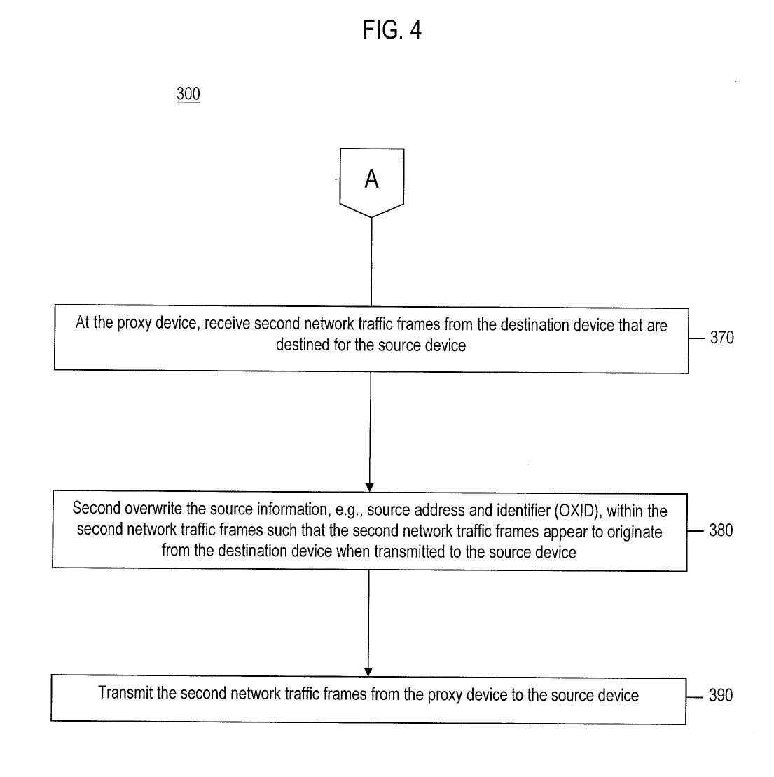

At 330, the proxy device logs into the destination device on behalf of the source device to obtain access to the destination device. The destination device is configured to allow access by the proxy server. In one example, the proxy server can perform read and write access to storage associated with the destination device, e.g., an FC storage array. At 340, first network traffic frames are received from the source device that are destined for the destination device. At 350, information within the first network traffic frames is overwritten such that the first network traffic frames appear to originate from the proxy device when transmitted to the destination device. An example, of how the proxy device overwrites information within frames is described in connection with FIG. 5. At 360, the first network traffic frames are transmitted from the proxy device to the destination device. The flow chart for the proxy process logic 300 continues in FIG. 4 when frames are to be sent in the opposite direction (from the destination device to the source device).

Turning to FIG. 4, proxy process logic 300 performs similar operations on frames sent from the destination device to the source device. At 370, second network traffic frames are received from the destination device that are destined for the source device. At 380, information within the second network traffic frames is overwritten such that the second network traffic frames appear to originate from the destination device when transmitted to the source device. At 390, the first network traffic frames are transmitted from the proxy device to the source device.

Referring to FIG. 5 also with reference to FIG. 1, a ladder diagram is shown that generally depicts service or data flows between physical FC servers and an FC storage array in which the proxy device rewrites source address information in the frames of the service flows. The depiction in FIG. 5 presumes that all logins are complete, network communications are in progress, and that the physical FC servers do not have direct access to the FC storage arrays. For simplicity of description, it is assumed that all the devices are in the same VSAN, although the techniques described herein are equally applicable if the devices in system 100 are in different VSANs and are communicating by way of Inter-VSAN Routing (IVR). Furthermore, the techniques described herein are applicable to Fiber Channel over Ethernet (FCoE) networks and devices.

An FC frame 510 is transmitted, as shown with a solid line arrow, from FC server 110(1) with an FCID of 20.1.1 intended for FC storage array 140(1) with an FCID of 10.1.1. FC frame 510 may be generated by FC server 110(1) or by VMs running on FC server 110(1) that use the same PWWN as the FC server 110(1). The FC frame 510 has a source FCID of 20.1.1, a destination FCID of 10.1.1, and an FC server generated OXID of Xa. The proxy server 150 is configured to receive all traffic from the FC server cluster intended for storage array 140(1) based on the destination FCID contained in the frame 510. That is, the switches in the network 120 redirect traffic addressed to the storage array 140(1) to the proxy server 150.

Redirection may be accomplished in a number of ways. In one example, the traffic may be redirected at the ports of the storage array, e.g., at the ports of storage arrays 140(1) and 140(2). In another example, the traffic is redirected at the ports of the FC servers, e.g., FC servers 110(1)-110(m). Redirection may be accomplished with an access control rule in an Access Control List (ACL), e.g., an ACL with redirect option is placed at the server ports in FC servers 110(1)-110(m) in the ingress direction such that any traffic from that server to the storage array port is redirected to the proxy device.

Thus, the proxy server 150 intercepts FC frame 510 with a destination FCID of 10.1.1. The proxy server 150 overwrites the source FCID 20.1.1 of the frame 510 with its FCID of 10.1.2 and overwrites the OXID with a proxy server generated OXID (proxy OXID) of Xb to produce FC frame 520. The proxy OXID is configured to uniquely identify a source port of the source device. The proxy server 150 may maintain its own pool of proxy OXIDs to avoid the possibility of multiple flows from the same or different FC servers having the same OXID, which could be the case if the proxy server 150 uses the OXID in the FC frames received from the FC servers. The proxy server 150 transmits FC frame 520 to the storage array 140(1).

An FC frame 530 is transmitted, as shown with a dashed line arrow, from FC server 110(m) with an FCID of 30.2.1 to FC storage array 140(1) with an FCID of 10.1.1. The FC frame 530 has a source FCID of 30.2.1, a destination FCID of 10.1.1 and an FC server generated OXID of Xa. Although the OXID of Xa is the same OXID as that used by FC server 110(1) for FC frame 510, this does not present an issue because the frame's FCIDs are unique and the service flows are thereby distinguishable by the proxy server 150. The network 120 redirects the FC frame 530 to the proxy server 150. The proxy server 150 overwrites the source FCID of 30.2.1 with its FCID of 10.1.2 and overwrites the FC server generated OXID Xa with a proxy server generated OXID of Xc to produce FC frame 540. FC frame 540 is transmitted to the storage array 140(1). The proxy server 150 maintains a response queue for frames 510 and 530 and will use the queue to match responses received from the FC storage array 140(1), i.e., The proxy server 150 generates information comprising the source OXID and the proxy OXID to map network traffic frames for the service flow. Also maintained in the queue are placeholders for responses that are due from the storage array 140(1) for FC frames 520 and 540. In other words, the response queue allows the proxy server 150 to track FC exchanges and in exchange sequence order for FC service flows to and from the FC servers, and to and from the storage arrays.

The FC storage array 140(1) responds to FC frame 520 with FC frame 550, as shown with a solid line arrow, to proxy server 150. The response frame has a source FCID of 10.1.1 for storage array 140(1), a destination FCID of 10.1.2 for proxy server 150, and the proxy server generated OXID of Xb. The proxy server 150 will use the Xb OXID to associate FC frame 550 with FC frame 520 using the pending response queue for storage array 140(1) in order to send the frame FC 550 to FC server 110(1) as a response to FC frame 510. The proxy server 150 overwrites the destination FCID of 10.1.2 with an FCID of 20.1.1 for the FC server 110(1), and overwrites the OXID Xb contained in FC frame 550 with the original FC server (source device) generated OXID of Xa to produce FC frame 560. The FC frame 560 is transmitted to the FC server 110(1) and is a response to FC frame 510. The FC server 110(1) is completely unaware that a proxy server was involved in the frame exchange.

Similarly, the FC storage array 140(1) responds to FC frame 540 with FC frame 570, as shown with a dashed line arrow, to proxy server 150. The response frame has a source FCID of 10.1.1 for storage array 140(1), a destination FCID of 10.1.2 for proxy server 150, and the proxy server generated OXID of Xc. The proxy server 150 will use the OXID Xc contained in frame 570 to associate it with FC frame 530 using the pending response queue for storage array 140(1) in order to send FC frame 570 to FC server 110(1) as a response to FC frame 540. The proxy server 150 overwrites the destination FCID of 10.1.2 with an FCID of 30.2.1 for the FC server 110(m), and overwrites the OXID Xc contained in FC frame 570 with the original FC server generated OXID of Xa to produce FC frame 580. The FC frame 580 is transmitted to the FC server 110(m) and is a response to FC frame 530. The FC server 110(m) is completely unaware that a proxy server was involved in the frame exchange Likewise, the storage array 140(1) is completely unaware that the physical FC servers 110(1) and 110(m) are being proxied by FC proxy server 150. Any LUN masking and access control at the storage array 140(1) may be performed based on the PWWN of the proxy server 150.

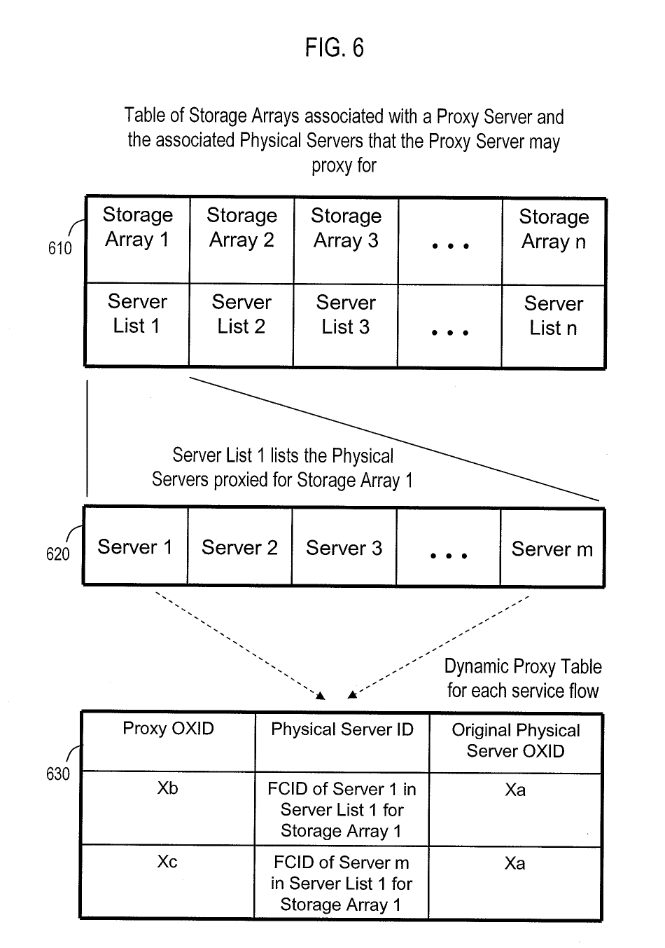

As can be seen from the above example, the proxy server multiplexes traffic from servers 110(1) and 110(m) into a single service flow with source FCID 10.1.2 for proxy server 150 and a destination FCID of 10.1.1 for storage array 140(1). The same proxy server can proxy for multiple physical servers as well as multiple storage arrays. Only the proxy server 150 needs to be logged into FC storage array 140(1) for FC servers 110(1)-110(m) to communicate with the storage array. The unique OXIDs within the FC frames identify the service flows to the FC storage array 140(1) and to the proxy server 150 when they are echoed by the FC storage array 140(1) in response frames sent back to the proxy server 150. The proxy server 150 then uses the unique OXIDs to demultiplex the FC frames back into the individual service flows to FC servers 110(1) and 110(m), respectively. The proxy server 150 maintains information to map service flows between the source devices and the destination devices. Example types of information are shown in FIG. 6.

As mentioned above, one possible implementation of the proxy functionality is at a switch with a switch port that is connected to the storage array. Frames sent from the physical servers to the storage array can be captured on ingress and the source FCID and OXID can be rewritten at the egress switch port connected to the storage array. Similarly, frames from the storage array to the proxy server can be captured at the ingress switch port where the storage array is connected, and the destination FCID and OXID can be rewritten before the frames are forwarded to the respective physical servers, as described above. The actual rewriting of the frames and OXID pool management may be implemented in an intelligent line card device with a programmable processor (e.g. Cisco System's SSN 16 line card with Octeon datapath processor or certain Brocade Serveriron modules) or via an ASIC.

In an intelligent line card the FC traffic is received and processed by one or more network processors. Software running on these network processors can be customized to implement the server proxy functionality. ACLs at the real physical server ports would be programmed to redirect traffic to the storage array ports to the intelligent line card. Alternatively, an ACL can be placed at the egress ports to the storage arrays such that the traffic to the storage ports from the physical servers are redirected to the intelligent line card while allowing traffic from the proxy server to the storage arrays to reach the storage arrays' ports.

Example tables of information that stored by proxy device to map service flows are shown in FIG. 6. At 610, a table is shown that has a list of FC storage arrays the proxy server may proxy for. The FC storage arrays are listed in the top row. A corresponding list of FC servers that the proxy device may proxy for is shown in the bottom row. At 620, an expanded view of Server list 1 is shown that list all the servers associated with Storage Array 1 that may be proxied for by the proxy server. At 630, a table is shown that maps proxy generated OXIDs with a physical server IDs and an original physical server OXIDs. The proxy server uses the tables and the response queue to select the appropriate OXIDs for overwriting when the FC frames are received at the proxy server. The proxy server may store this information in any form, e.g., in memory, hierarchical or relational databases, programmable registers, etc.

When a new FC server is added to the server cluster no changes to the storage arrays are required. The network, e.g., network 120 (FIG. 1), automatically understands that the new FC server is in the same FC server virtualization cluster and would start proxying for it, i.e., by directing FC frames from the new FC server to an appropriate proxy server in the network. Server proxy information is automatically added to the tables 610-630 at the proxy server. The determination that the new server is in the same FC cluster can be made in various ways, e.g., by FC zone membership. For example, if the new server is added to the same zone that FC servers 110(1)-110(m) belong to, then the new server can be assumed to be part of the same virtualization cluster.

Proxy server logic may be implemented at the ASIC level with OXID pool management functionality in the ASIC. Rewrites of the FCIDs are deterministic, e.g., using ACLs. For an OXID rewrite, the ASIC maintains a table of the original OXID, the original server FCID or logical name, and the new OXID as shown in FIG. 6. When a new exchange is seen by the ASIC, e.g., if the original OXID and original server ID are not in the tables, then a new and currently unused OXID is allocated, and marked unavailable in the OXID pool. A corresponding entry is added to the tables and the frame OXID is rewritten using the new OXID. The “currently unused OXID” pool may be implemented on a per-proxy server basis or the unused OXIDs may be shared among multiple proxy servers. Subsequent frames of the same exchange would use the same “new” OXID. When the exchange is terminated, e.g., as determined by end-of-exchange bit in the frame, the corresponding entry is removed from the tables and the corresponding “new” OXID is marked as available. Since FC clusters only support a limited number of servers or hosts, a 32, 64, or 128, a 16-bit wide OXID field is large enough to support multiple proxy servers, i.e., more than 65,000 (˜2¹⁶) OXIDs are available for a virtualization cluster.

Techniques are provided herein for receiving at a proxy device in a network, a login request from a source device to access a destination device. The source device does not have direct access the destination device. A response to the login request is sent that is configured to appear to the source device that the response is from the destination device. The proxy device logs into the destination device on behalf of the source device to obtain access to the destination device. The proxy device receives first network traffic frames associated with a service flow between the source device and the destination device from the source device that are destined for the destination device. Information is overwritten within the first network traffic frames such that the first network traffic frames appear to originate from the proxy device when transmitted to the destination device. The first network traffic frames are transmitted from the proxy device to the destination device.

Techniques are provided herein for performing similar operations on frames sent from the destination device to the source device. At the proxy device, second network traffic frames are received from the destination device that are destined for the source device. Information within the second network traffic frames is overwritten such that the second network traffic frames appear to originate from the destination device when transmitted to the source device. The second network traffic frames are transmitted from the proxy device to the source device.

In summary, the techniques described herein vastly reduce the operational steps for provisioning a new server to an existing server cluster by eliminating administrator functions for the storage arrays and the number of storage array logins are reduced by the proxy server's ability to multiplex traffic from multiple servers to the storage array.

The above description is intended by way of example only.

What is claimed is:

1. A method comprising:
at a proxy device in a network, receiving a login request from a source device to access a destination device, wherein the source device does not have direct access to the destination device;
sending a response to the login request configured to appear to the source device that the response is from the destination device;
at the proxy device, logging into the destination device on behalf of the source device to obtain access to the destination device;
at the proxy device, receiving first network traffic frames associated with a service flow between the source device and the destination device from the source device that are destined for the destination device;
first overwriting information within the first network traffic frames such that the first network traffic frames appear to originate from the proxy device when transmitted to the destination device; and
transmitting the first network traffic frames from the proxy device to the destination device.

2. The method of claim 1, further comprising:
at the proxy device, receiving second network traffic frames from the destination device that are destined for the source device;
second overwriting information within the second network traffic frames such that the second network traffic frames appear to originate from the destination device when transmitted to the source device; and
transmitting the second network traffic frames from the proxy device to the source device.

3. The method of claim 2, wherein first overwriting comprises overwriting a source device generated originator exchange identifier (OXID) within the first network traffic frames that is configured to identify the service flow for the source device with a proxy OXID that is configured to identify the service flow for the proxy device and overwriting a Fiber Channel Identifier (FCID) configured to identify the source device with an FCID configured to identify the proxy device.

4. The method of claim 3, wherein second overwriting comprises overwriting the proxy OXID included within the second network traffic frames with the source device generated OXID that identifies the service flow for the source device and overwriting the FCID that identifies the proxy device with the FCID for the source device.

5. The method of claim 4, and further comprising storing at the proxy device information to track service flows to and from each of a plurality of source devices, and to and from each of a plurality of destination devices.

6. The method of claim 2, wherein receiving the login request from the source device comprises receiving from a Fiber Channel server in a Fiber Channel server cluster a request to access a Fiber Channel storage array.

7. The method of claim 2, wherein receiving first network traffic frames comprises receiving first network traffic frames at a switch in a Fiber Channel network that is configured route traffic between the Fiber Channel server cluster and the Fiber Channel storage array.

8. The method of claim 2, further comprising:
generating a proxy originator exchange identifier (OXID) that is configured to uniquely identify a source port of the source device;
extracting a source OXID from the first network traffic frames that is configured to identify a source port of the source device; and
generating information comprising the source OXID and the proxy OXID to map network traffic frames for the service flow.

9. An apparatus comprising:
one or more network interfaces configured to communicate over a network; and
a processor configured to be coupled to the one or more network interfaces and configured to:
receive a login request from a source device to access a destination device, wherein the source device does not have direct access to the destination device;
send a response to the login request configured to appear to the source device that the response is from the destination device;
log into the destination device on behalf of the source device to obtain access to the destination device;
receive first network traffic frames associated with a service flow between the source device and the destination device from the source device that are destined for the destination device;
first overwrite information within the first network traffic frames such that the first network traffic frames appear to originate from a proxy device when transmitted to the destination device; and
transmit the first network traffic frames from the proxy device to the destination device.

10. The apparatus of claim 9, wherein the processor is further configured to:
receive second network traffic frames from the destination device that are destined for the source device;
second overwrite information within the second network traffic frames such that the second network traffic frames appear to originate from the destination device when transmitted to the source device; and
transmit the second network traffic frames from the proxy device to the source device.

11. The apparatus of claim 10, wherein the processor is configured to first overwrite a source device generated originator exchange identifier (OXID) within the first network traffic frames that is configured to identify the service flow for the source device with a proxy OXID that is configured to identify the corresponding service flow for the proxy device and overwriting a Fiber Channel Identifier (FCID) configured to identify the source device with an FCID configured to identify the proxy device.

12. The apparatus of claim 11, wherein the processor is configured to second overwrite the proxy OXID included within the second network traffic frames with the source device generated OXID that identifies the service flow for the source device and overwriting the FCID that identifies the proxy device with the FCID for the source device.

13. The apparatus of claim 12, wherein the processor is further configured to store device information to track service flows to and from each of a plurality of source devices, and to and from each of a plurality of destination devices.

14. The apparatus of claim 10, wherein the processor is further configured to:
generate a proxy originator exchange identifier (OXID) that is configured to identify a source port of the source device;
extract a source OXID from the first network traffic frames that is configured to identify a source port of the source device; and
generate information comprising the source OXID and the proxy OXID to map network traffic frames for the service flow.

15. A computer readable medium storing instructions that, when executed by a processor, cause the processor to:
at a proxy device, receive a login request from a source device to access a destination device, wherein the source device does not directly access the destination device;
send a response to the login request configured to appear to the source device that the response is from the destination device;
log into the destination device on behalf of the source device to obtain access to the destination device;
receive first network traffic frames associated with a service flow between the source device and the destination device from the source device that are destined for the destination device;
first overwrite information within the first network traffic frames such that the first network traffic frames appear to originate from the proxy device when transmitted to the destination device; and
transmit the first network traffic frames from the proxy device to the destination device.

16. The computer readable medium of claim 15, further comprising instructions that, when executed by the processor, cause the processor to:
receive second network traffic frames from the destination device that are destined for the source device;
second overwrite information within the second network traffic frames such that the second network traffic frames appear to originate from the destination device when transmitted to the source device; and
transmit the second network traffic frames from the proxy device to the source device.

17. The computer readable medium of claim 16, wherein the instructions that cause the processor to first overwrite comprise instructions that cause the processor to overwrite a source device generated originator exchange identifier (OXID) within the first network traffic frames that is configured to identify the service flow for the source device with a proxy OXID that is configured to identify the service flow for the proxy device and overwriting a Fiber Channel Identifier (FCID) configured to identify the source device with an FCID configured to identify the proxy device.

18. The computer readable medium of claim 17, wherein the instructions that cause the processor to second overwrite comprise instructions that cause the processor to overwrite the proxy OXID included within the second network traffic frames with the source device generated OXID that identifies the service flow for the source device and overwriting the FCID that identifies the proxy device with the FCID for the source device.

19. The computer readable medium of claim 18, further comprising instructions that, when executed by the processor, cause the processor to store information to track service flows to and from each of a plurality of source devices, and to and from each of a plurality of destination devices.

20. The computer readable medium of claim 16, further comprising instructions that, when executed by the processor, cause the processor to:
generate a proxy originator exchange identifier (OXID) that is configured to identify a source port of the source device;
extract a source OXID from the first network traffic frames that is configured to identify a source port of the source device; and
generate information comprising the source OXID and the proxy OXID to map network traffic frames for the service flow.
